(19) United States
(12) Patent Application Publication
(10) Pub. No.: US 2011/0240526 A1
(43) Pub. Date: Oct. 6, 2011

(54) Debris Separation Device and Method of Use

(75) Inventors: Robert F. Tammera, Warrenton, VA (US); Dominic C. Rigano, Warrenton, VA (US)

(73) Assignee: EXXONMOBIL RESEARCH AND ENGINEERING COMPANY, Annandale, NJ (US)

(21) Appl. No.: 13/030,596

(22) Filed: Feb. 18, 2011

Related U.S. Application Data
(60) Provisional application No. 61/341,361, filed on Mar. 30, 2010.

(51) Int. Cl. C10G 31/00; B01J 8/00

(52) U.S. Cl. 208/308; 422/187

(57) ABSTRACT

A device for use in separating debris from a flowing stream which comprises a substantially hollow, substantially conical shaped structure comprising a top end member and a plurality of adjacently positioned side members angularly extending from a top end member to a substantially circular bottom end. The top end member has a smaller diameter than the circular bottom end. The adjacently positioned side members are configured to provide multiple tiers in a vertical plane in the conically shaped structure. The multiple tiers comprise a plurality of apertures in a horizontal plane in the conically shaped structure. The plurality of apertures are configured for separating large debris particles, generally formed from coke and spent catalyst, from a flowing fluidized catalytic cracking stream, and directing the captured debris toward the circular bottom end of the device. A method of separating debris from a flowing stream is also provided. In particular, the device and method are useful for separating coke deposits in a fluidized catalytic cracking (FCC) process.

This application claims the benefit of U.S. Provisional Application No. 61/341,361 filed Mar. 30, 2010.

### FIELD OF THE DISCLOSURE

This disclosure relates to devices for use in separating debris, e.g., coke, from a flowing stream, e.g., a hydrocarbon or hydrocarbon/catalyst stream in a fluidized catalytic cracking (FCC) process, and to methods of separating debris from a flowing stream.

### DISCUSSION OF THE BACKGROUND ART

A variety of processes contact finely divided particulate material with a hydrocarbon containing feed under conditions wherein a fluid maintains the particles in a fluidized condition to effect transport of the solid particles to different stages of the process. FCC is an example of such a process that contacts hydrocarbons in a reaction zone with a catalyst composed of finely divided particulate material.

A FCC unit comprises a reaction zone and a catalyst regeneration zone. In the reaction zone, a feed stream is contacted with finely divided fluidized solid particles or catalyst maintained at an elevated temperature and at a moderate positive pressure. Contacting of feed and catalyst usually takes place in a riser conduit, but may occur in any effective arrangement known devices for short contact time contacting. In the case of a riser, a principally vertical conduit comprises the main reaction site, with the effluent of the conduit emptying into a large volume process vessel, which is called the reactor vessel or may be referred to as a separation vessel. The residence time of catalyst and hydrocarbons in the riser needed for substantial completion of the cracking reactions is only a few seconds or less.

The flowing hydrocarbon vapor/catalyst stream leaving the riser may pass from the riser to a solids-vapor separation device located within the separation vessel or may enter the separation vessel directly without passing through an intermediate separation apparatus. When no intermediate apparatus is provided, much of the catalyst drops out of the flowing hydrocarbon vapor/catalyst stream as the stream leaves the riser and enters the separation vessel. One or more additional solids/vapor separation devices, almost invariably a cyclone separator, are normally located within and at the top of the large separation vessel. The products of the reaction are separated from a portion of catalyst, which is still carried by the vapor stream, by means of the cyclone or cyclones and the hydrocarbon vapor is vented from the cyclone and separation vessel. The spent catalyst falls downward to a lower location within the separation vessel. As used herein, the term “spent catalyst” is intended to indicate catalyst employed in the reaction zone that is being transferred to the regeneration zone for the removal of coke deposits. The term is not intended to be indicative of a total lack of catalytic activity by the catalyst particles. The term “used catalyst” is intended to have the same meaning as the term “spent catalyst”.

Catalyst is continuously circulated from the reaction zone to the regeneration zone and then again to the reaction zone. The catalyst therefore acts as a vehicle for the transfer of heat from zone to zone as well as providing the necessary catalytic activity. Any FCC catalyst can be used in the process. The catalyst particles will typically have a size of less than 100 microns. Catalyst which is being withdrawn from the regeneration zone is referred to as “regenerated” catalyst. The catalyst charged to the regeneration zone is brought into contact with an oxygen-containing gas such as air or oxygen-enriched air under conditions which result in combustion of the coke. This results in an increase in the temperature of the catalyst and the generation of a large amount of hot gas which is removed from the regeneration zone as a gas stream referred to as a flue gas stream. The regeneration zone is normally operated at a temperature of from about 600° C. to about 800° C.

A majority of the hydrocarbon vapors that contact the catalyst in the reaction zone are separated from the solid particles by ballistic and/or centrifugal separation methods within the reaction zone. However, the catalyst particles employed in a FCC process have a large surface area, which is due to a significant amount of pores located in the particles. As a result, the catalytic materials retain hydrocarbons within their pores, upon the external surface of the catalyst and in the spaces between individual catalyst particles, as they enter the stripping zone. Although the quantity of hydrocarbons retained on each individual catalyst particle is very small, the large amount of catalyst and the high catalyst circulation rate which is typically used in a modern FCC process results in a significant quantity of hydrocarbons being withdrawn from the reaction zone with the catalyst.

Therefore, it is common practice to remove, or strip, hydrocarbons from spent catalyst prior to passing the catalyst into the regeneration zone. Greater concentrations of hydrocarbons on the spent catalyst that enters the regenerator increase its relative carbon-burning load and result in hotter regenerator temperatures. Avoiding the unnecessary burning of hydrocarbons is especially important during the processing of heavy (relatively high molecular weight) feedstocks, since processing these feedstocks increases the deposition of coke on the catalyst during the reaction, in comparison to the coking rate with light feedstocks, and raises the temperature in the regeneration zone. Improved stripping permits cooler regenerator temperatures and higher conversion.

The most common method of stripping the spent catalyst includes passing a stripping gas, usually steam, through a flowing stream of catalyst, counter-current to its direction of flow. Such steam stripping operations, with varying degrees of efficiency, remove the hydrocarbon vapors which are entrained with the catalyst and adsorbed on the catalyst.

The efficiency of catalyst stripping is increased by using vertically spaced baffles to cascade the catalyst from side to side as it moves down a stripping apparatus and counter-currently contacts a stripping medium. Moving the catalyst horizontally increases contact between the catalyst and the stripping medium so that more hydrocarbons are removed from the catalyst. In these arrangements, the catalyst is given a labyrinthine path through a series of baffles located at different levels. Catalyst and gas contact is increased by this arrangement that leaves substantially no open vertical path of significant cross-section through the stripping apparatus.

However, the coke and catalyst particles can conglomerate during the FCC process, to form large debris particles. This debris particle formation can be particularly extensive in the stripping section of an FCC unit where the coke and spent catalyst particles are commonly subjected to stripping steam which can contribute in the binding process of these hot particles into larger debris particles. These larger debris particles can generally pass through the stripper section which generally comprises large open passage areas through the stripper section. However, these larger debris particles can cause significant problems downstream of the stripping section by causing blockages in slide valves and other related FCC equipment, resulting in pressure drop and restricted flow issues, as well as causing problems in the lift gas and catalyst regeneration sections of an FCC process.

Therefore, a need exists for effectively segregating and isolating large debris particles in a FCC process without experiencing the performance disadvantages described above. In particular, a need exists for a simple and effective method for maintaining a level of operating throughput in a FCC unit as coke debris particles are collected.

The present disclosure provides many advantages, which shall become apparent as described below.

### SUMMARY OF THE DISCLOSURE

This disclosure relates in part to a device for use in separating debris from a flowing stream in a fluidized catalytic cracking vessel which comprises:

a substantially hollow, conically shaped structure comprising a top end member and a plurality of adjacently positioned angled vertical plate members angularly extending from the top end member and forming a circular bottom end;

wherein the top end member has a smaller diameter than the circular bottom end;

wherein the adjacently positioned angled vertical plate members are secured together and to the top end member, and configured to provide multiple tiers in a vertical plane in the substantially hollow, conically shaped structure;

wherein the multiple tiers comprise a plurality of apertures in a horizontal plane in the substantially hollow, conically shaped structure, the plurality of apertures configured for separating debris particles from a flowing stream, and directing the debris toward the circular bottom end; and

wherein the circular bottom end is mechanically attached to the internal wall of a fluidized catalytic cracking unit vessel and provides effective screening of the entire diameter of the fluidized catalytic cracking unit vessel at the plane in the fluidized catalytic cracking unit vessel where the circular bottom end is mechanically attached to the internal wall of the fluidized catalytic cracking unit vessel.

This disclosure also relates in part to a method of separating debris from a flowing stream in a fluidized catalytic cracking vessel which comprises:

(a) providing a debris separation device comprising:

a substantially hollow, conically shaped structure comprising a top end member and a plurality of adjacently positioned angled vertical plate members angularly extending from the top end member and forming a circular bottom end;

wherein the top end member has a smaller diameter than the circular bottom end;

wherein the adjacently positioned angled vertical plate members are secured together and to the top end member, and configured to provide multiple tiers in a vertical plane in the substantially hollow, conically shaped structure;

wherein the multiple tiers comprise a plurality of apertures in a horizontal plane in the substantially hollow, conically shaped structure, the plurality of apertures configured for separating debris particles from a flowing stream, and directing the debris toward the circular bottom end; and

wherein the circular bottom end is mechanically attached to the internal wall of a fluidized catalytic cracking unit vessel and provides effective screening of the entire diameter of the fluidized catalytic cracking unit vessel at the plane in the fluidized catalytic cracking unit vessel where the circular bottom end is mechanically attached to the internal wall of the fluidized catalytic cracking unit vessel.

(b) flowing a stream containing debris particles through the device;

(c) separating debris from the flowing stream; and

(d) directing the debris toward the circular bottom end.

This disclosure further relates in part to a method of separating debris from a flowing stream in a fluidized catalytic cracking vessel which comprises:

(a) providing a fluidized catalytic cracking unit comprising a reaction zone, a stripping zone, and a catalyst regeneration zone;

(b) providing a debris separation device positioned and mechanically connected to the internal vessel wall of a fluidized catalytic cracking vessel between the stripping zone and the catalyst regeneration zone of the fluidized catalytic cracking unit, the debris separation device comprising:

a substantially hollow and conically shaped structure comprising a top end member and a plurality of adjacently positioned angled vertical plate members angularly extending from the top end member and forming a circular bottom end;

wherein the top end member has a smaller diameter than the circular bottom end;

wherein the adjacently positioned angled vertical plate members are secured together and to the top end member, and configured to provide multiple tiers in a vertical plane in the substantially hollow and conically shaped structure;

wherein the multiple tiers comprise a plurality of apertures in a horizontal plane in the substantially hollow and conically shaped structure, the plurality of apertures configured for separating debris particles from a flowing stream, and directing the debris toward the circular bottom end; and

wherein debris separation device provides effective screening of the entire diameter of the fluidized catalytic cracking unit vessel at the plane in the fluidized catalytic cracking unit vessel where the circular bottom end is mechanically attached to the internal wall of the fluidized catalytic cracking unit vessel;

(c) flowing a stream containing debris particles through the device;

(d) separating debris from the flowing stream; and

(e) directing the debris toward the circular bottom end.

Further objects, features and advantages of the present disclosure will be understood by reference to the following drawings and detailed description.

### BRIEF DESCRIPTION OF THE DRAWINGS

FIG. 1A depicts an isometric, three-dimensional view of an embodiment of the debris separation device.

FIG. 1B depicts an elevation view of an embodiment of the debris separation device.

FIG. 1C depicts an isometric, three-dimensional view of an embodiment of the debris separation device as utilized in a central riser FCC reactor vessel.

FIG. 2 illustrates an embodiment of the debris separation device as installed in a fluidized catalytic cracking (FCC) reactor vessel.

FIG. 3 illustrates an embodiment of the modular construction of the debris separation device for ease of modular pre-fabrication and installation in a fluidized catalytic cracking (FCC) reactor vessel.

FIG. 4 depicts a cross-sectional elevation view of an embodiment of the debris separation device.

### DETAILED DESCRIPTION OF THE PREFERRED EMBODIMENT

This disclosure relates to improved internal separation and collection components for use in a fluid solids reactor unit, more particularly downstream to the systems gaseous stream and catalyst/hydrocarbon separation zone (i.e., stripper zone). The separation and collection device of this disclosure affords improved control of coke accumulations that form upstream to the device location. A feature of this disclosure is to maintain a level of operating throughput as coke deposits are collected. The mechanical design of the device allows it to be implemented into either a fluidized catalytic cracking (or “FCC”) vessel cone or cylindrical sections.

In a typical FCC process in which the separation and collection devices of this disclosure may be used, the typical feed to a FCC unit is a gas oil such as a light or vacuum gas oil. Other petroleum-derived feed streams to a FCC unit may comprise a diesel boiling range mixture of hydrocarbons or heavier hydrocarbons such as reduced crude oils. It is preferred that the feed stream consist of a mixture of hydrocarbons having boiling points above about 230° C. (446° F.) and more preferably above about 290° C. (554° F.). It is becoming customary to refer to FCC-type units which are processing heavier feedstocks, such as atmospheric reduced crudes, as residual crude cracking units, or residual cracking units. The separation device of this disclosure can be used for any FCC operations including residual cracking operations.

The reaction zone of a FCC process, which is normally referred to as a “riser” due to the widespread use of a vertical tubular conduit or pipe, is maintained at high temperature conditions which generally include a temperature above about 425° C. (797° F.). Preferably, the reaction zone is maintained at cracking conditions which include a temperature of from about 480° C. (896° F.) to about 590° C. (1094° F.) and a pressure of from about 65 kPa (9.4 psi) to about 500 kPa (72.5 psi), but preferably less than about 275 kPa (39.9 psi). The catalyst-to-oil ratio, based on the weight of catalyst and feed hydrocarbons entering the bottom of the riser, may range up to 20:1 but is preferably between about 4:1 and about 10:1. On occasion, steam may be passed into the riser. The average residence time of catalyst in the riser is preferably less than about 5 seconds. The type of catalyst employed in the process may be chosen from a variety of commercially available catalysts. A catalyst comprising a zeolite base material is preferred, but amorphous catalysts can also be used.

The catalyst regeneration zone is preferably operated at a pressure of from about 35 kPa (5.1 psi) to about 500 kPa (72.5 psi). The spent catalyst being charged to the regeneration zone may contain from about 0.2 weight percent to about 15 weight percent coke. This coke is predominantly comprised of carbon and can contain from about 3 weight percent to about 12 weight percent hydrogen, as well as sulfur and other elements. The oxidation of coke will produce the common combustion products such as water, carbon oxides, sulfur oxides and nitrous oxides. The regeneration zone may take several configurations, with regeneration being performed in one or more stages. Further variety is possible due to the fact that regeneration may be accomplished with the fluidized catalyst being present as either a dilute phase or a dense phase within the regeneration zone. The term “dilute phase” is intended to indicate a catalyst/gas mixture having a density of less than 300 kg/m³. In a similar manner, the term “dense phase” is intended to mean that the catalyst/gas mixture has a density equal to or more than 300 kg/m³. Representative dilute phase operating conditions often include a catalyst/gas mixture having a density of about 15 to about 150 kg/m³.

As indicated above, large debris particles (e.g., coke or coke/catalyst conglomerations) that form during a FCC process can have a detrimental effect on the process. The debris particles may also contain portions of the vessel castable lining material that has spalled from the FCC vessel wall. These debris particles tend to be problematic above about 4 to 6 inches in diameter, and particularly problematic when they reach above about 8 to 12 inches in diameter. It should be noted that the term “diameter” when referring to debris particles as utilized herein means the largest linear dimension of the debris particle. In accordance with this disclosure, debris particles are separated and collected on a substantially hollow and substantially cone shaped structure device (or “debris separation device”) at desired locations in a FCC unit. A preferred location is between the stripper zone and the catalyst regeneration zone and can be either in a vessel cone or a cylindrical section. In a more preferred embodiment, the debris separation device is located in an FCC reactor vessel, at a position below the stripping section of the FCC reactor vessel. In an even more preferred embodiment, the debris separation device is located in an FCC reactor vessel, in a conical section of the FCC reactor vessel at a position below the stripping section of the FCC reactor vessel. In accordance with this disclosure, a desired level of operating throughput is maintained in the FCC unit as coke deposits (or “debris particles”) are collected.

The separation device can be any suitable substantially hollow and substantially cone shaped structure that (1) retains debris particles and directs the debris particles to the outer extremities of the device, and (2) has a shape that promotes and/or serves to maintain a level of operating throughput as debris particles, e.g., coke deposits, are collected. The device can be formed from any suitable material that can withstand the operating conditions of the FCC unit. Examples of suitable materials include metals and non-metallic materials capable of withstanding operating temperatures above about 590° C. (1094° F.). Preferably, the debris separation device is comprised a metal. Preferred metals of construction are carbon steel, carbon-1/2 moly steel, and stainless steel. In a preferred embodiment of the debris separation device, the components of the device can be easily machined and welded. In another preferred embodiment, the device is comprised of segments formed from ⅛ inch to ½ inch thick metal plates.

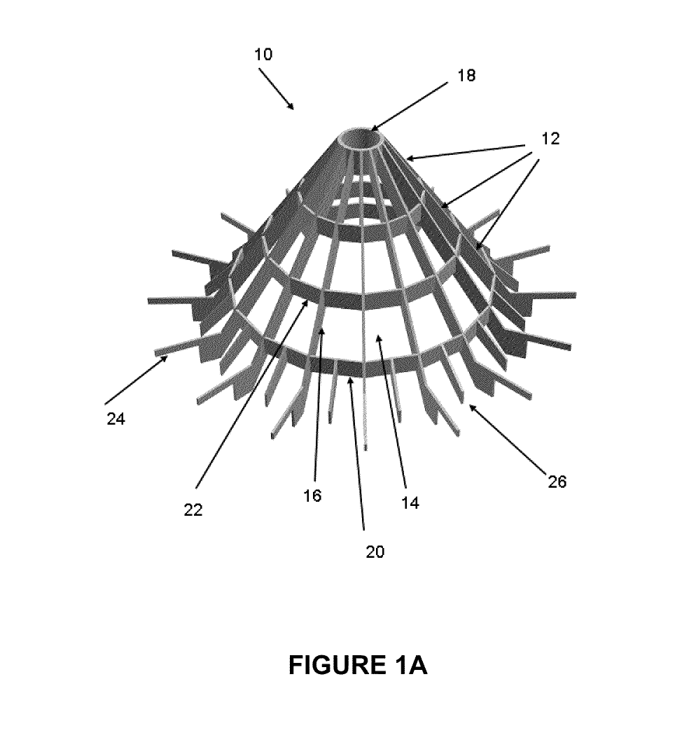

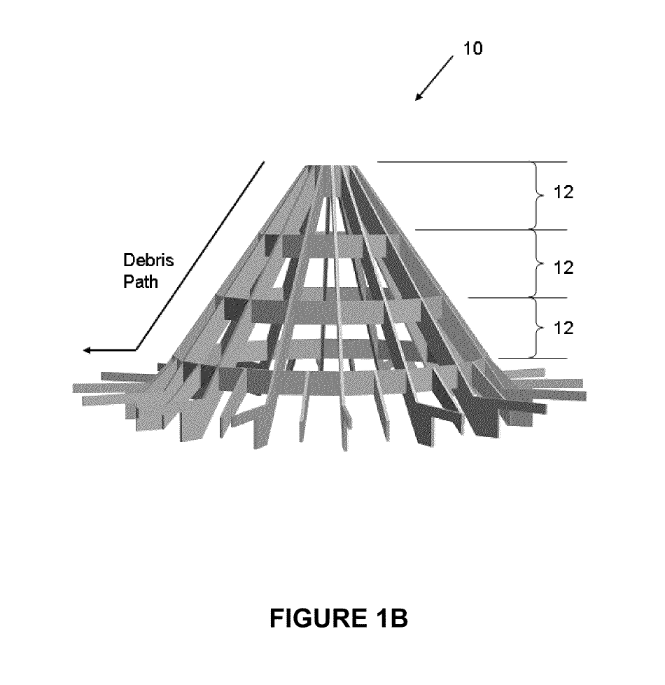

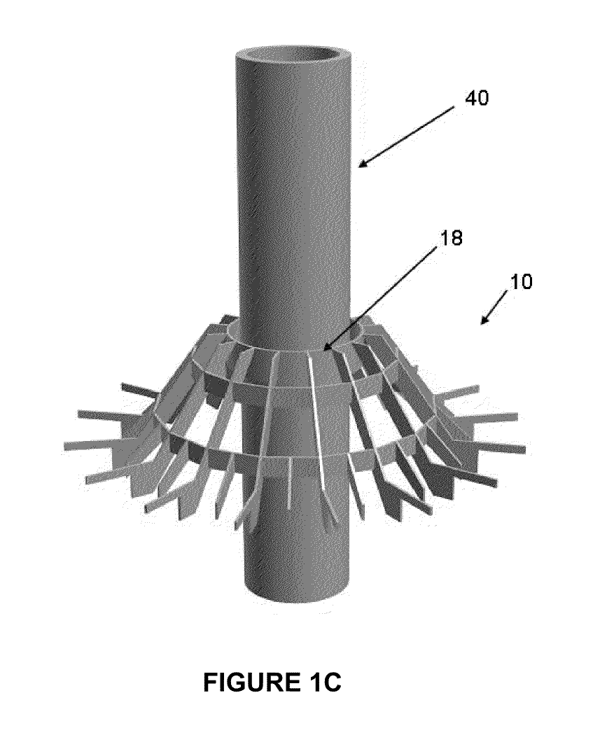

A preferred embodiment of the debris separation device 10 is illustrated in isometric view in FIG. 1A and an elevation view in FIG. 1B. A significant feature of the device 10 of this disclosure is that it emulates the profile of a cone or more specifically as shown in FIGS. 1A and 1B, emulates the profile of a truncated cone. The structure is preferably established by integrating flat plate, which after assembly resembles the conical profile. Preferably, the structure is divided in the vertical plane into multiple tier levels 12 (e.g., four-tier levels as shown in the exemplary figures), which establish the multiple flow apertures 14. In addition to defining the maximum diameter of these separate flow passages, these tiers also provide structural support to the overall device.

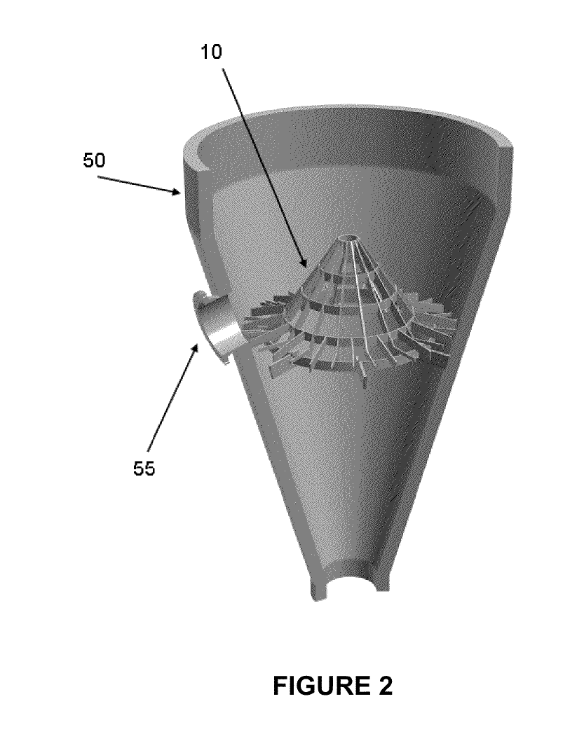

A process benefit of the structure design is to reduce the pressure drop by expanding each screening area into multiple vertical tier levels as shown in FIG. 1B, element 12 which provides increased overall flow area as well as diverts the debris particles to the outer diameter of the debris separation device 10 maintaining a clear flow path in the center of the FCC vessel 50 (See FIG. 2). Separating and collecting coke formations is a main function of the conical device. The practical function of the conical shape is to direct coke particles to the outer extremities of the device structure. The angled vertical plate members 16 will translate the deposits without imposing a significant blinding effect onto the process flow path, or increase the expected pressure drop range.

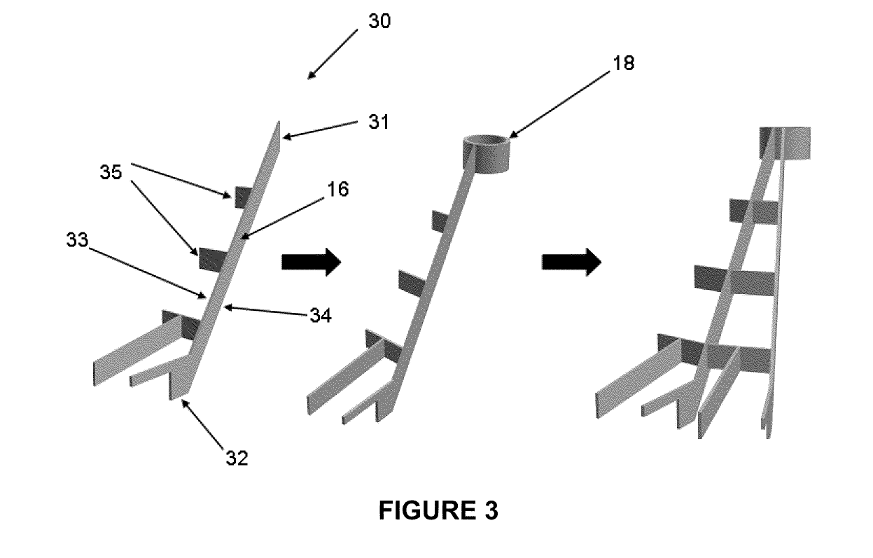

FIG. 1C herein illustrates another preferred embodiment of the debris separation device 10. This embodiment of the debris separation device is utilized in central riser FCC reactors wherein the reactor riser passes through the stripping zone and through the debris separation device 10 itself. The central riser is shown as element 40 in FIG. 1C and is not part of the debris separation device 10. Preferably in this embodiment as shown in FIG. 3, the top end member 18 is comprised of a hollow ring wherein the hollow ring has an internal diameter from about 12 inches to about 24 inches.

Preferably, the debris separation does not physically contact the central riser 40 but encircles the riser with an annular gap designed to block the flow of substantially sized debris particles. Preferably, the radial dimension of the annular gap between the central riser 40 and the top end member 18 of the debris separation device is between 2 and 12 inches, more preferably, between 3 and 10 inches. In other embodiments, the central riser 40 and top end member 18 may be designed with slide plates in order to help guide movement of the central riser relative to the debris separation device as the FCC unit vessel thermally expands and contracts. All other elements of the embodiment of the debris separation device as shown in FIG. 1C are similar in design and function to their numbered counterparts in FIG. 1A.

The separation devices of this disclosure exhibit structural integrity. The robust strength of the structure to withstand debris scatter is developed by integrating, for example, flat plate into its conical shape. The yield strength of having the divider plates in an angular plane is more resilient to impact as opposed to a level plane. The device can be fabricated from standard flat plate, requiring no special fabrication or machining techniques. This is a desirable benefit for controlling fabrication and implementation cost.

Field assembly is a desired attribute of the devices of this disclosure. As is illustrated in FIG. 3, the conical shape is developed by fabricating identical angled vertical plate members 16. These light weight members components can be duplicated in plurality in a fabricators shop. The angled vertical plate members 16 can be brought into the vessel and pattern welded to one another to form the conical debris screen. The individual angled vertical plate members 16 can be passed through a standard vessel access nozzle. Once installed the device will not hinder vessel access. This is a desirable design feature for workmen access for the initial implementation and future inspection and maintenance procedures.

Referring to FIGS. 1A, 1B, 1C and 2, the device 10 for use in separating debris particles from a flowing stream is a hollow conical-like structure that has a top end member 18 and a plurality of adjacently positioned angled vertical plate members 16 angularly extending from the top end member 18 forming a circular bottom end 20. The top end member 18, can be any shape conducive for construction, but most preferably the top end member is in the shape of a cylinder or cone. The cylinder or cone of the top end member may be solid or hollow, as illustrated in FIG. 1A. The top end member 18 has a smaller diameter than the circular bottom end 20. The adjacently positioned angled vertical plate members 16 are secured together via the horizontal support members 22 and to the top end member 18 and configured to provide multiple tiers 12 in a vertical plane as well as multiple flow apertures 14 in the hollow conical-like structure. The plurality of apertures 14 are configured for separating debris particles from a flowing stream, and directing the debris particles toward the circular bottom end 20 of the debris separation device as shown in FIG. 1B. In preferred embodiments, the circular bottom end 20 is preferably positioned in close proximity with the internal wall of the FCC vessel 50 (see FIG. 2) which creates an annular area where the debris particles can collect without significantly impacting the flow area through the conical portion of the debris separation device.

The circular bottom end 20 may be directly welded or secured to the internal wall of the FCC vessel 50, or may be attached to or rest on a support ring (not shown) attached to the internal wall of the FCC vessel 50. However, in a preferred embodiment, as shown in FIG. 1A, the debris separation device 10 is attached to the internal wall of the FCC vessel via a series of support members 24 that are attached on one end to the circular bottom end 20 of the debris separation device 10 and on the other end to the internal wall of the FCC vessel 50, or a support member extending therefrom. In a preferred embodiment, the support members 24 are made from steel plate. In another preferred embodiment, the support members 24 are positioned in a substantially horizontal plane with respect to the FCC vessel 50 so as to provide an annular area between the circular bottom end 20 and the internal wall of the FCC vessel 50. This area can be used to maximize the amount of buildup of debris particles segregated by the device with minimal restriction of the overall flow area of the device 10. In an even more preferred embodiment, the circular bottom end 20 is equipped with annular extension members 26 to assist in the capture and support of the debris particles in this annular area.

It should be noted that terms such as “secured”, “attached”, “connected” or similar should be construed herein as being equivalents and having the meaning when used herein that the at least two elements being “secured”, “attached”, or “connected” are physically connected to each other by means known in the art, such as but not limited to, welded, bolted, screwed, clamped, or through the use of any other mechanical device or method commonly known in the art, and does not exclude the use of intervening connecting structures unless as specifically mentioned in the context of the particular description.

FIG. 2 illustrates an elevation view of an embodiment of the debris separation device 10 installed in a conical section of an FCC vessel 50. The debris separation device 10 may be installed in either a conical section (as shown) a cylindrical section of the FCC vessel 50. FIG. 2 also shows a manway 55, located in the FCC vessel 50 which can be used for access for installation of the debris separation device 10 as well as inspection.

FIG. 3 illustrates how the debris separation device can be assembled via modular parts. Here the modular parts 30 are comprised of the angled vertical plate members 16 configured from flat elongated plate-like structures having a top end 31 and a bottom end 32, a front side 33 and a back side 34, and a plurality of flat elongated plate-like structures 35 extending from the angled vertical plate members 16. Preferably, the plurality of flat elongated plate-like structures 35 extend from the front side 33 of the angled vertical plate members 16. The top end 31 is capable of being secured, e.g., welded, to the top member 18. The bottom end 34 is capable of being positioned and secured, e.g., welded, to the circular bottom end 20 of the debris separation device. The plurality of flat elongated plate-like structures 35 preferably make up the horizontal support members 22 when the device is fully assembled. In this manner the modular parts 30 are light weight shop fabricated components that are replicated in plurality so they can be pre-formed and then pattern welded to form the hollow conical-like structure after inserting the modular parts 30 into the FCC vessel 50 (see FIG. 2). In this manner, the modular parts can be easily fitted through a vessel manway 55 (see FIG. 2) for field installation or removal.

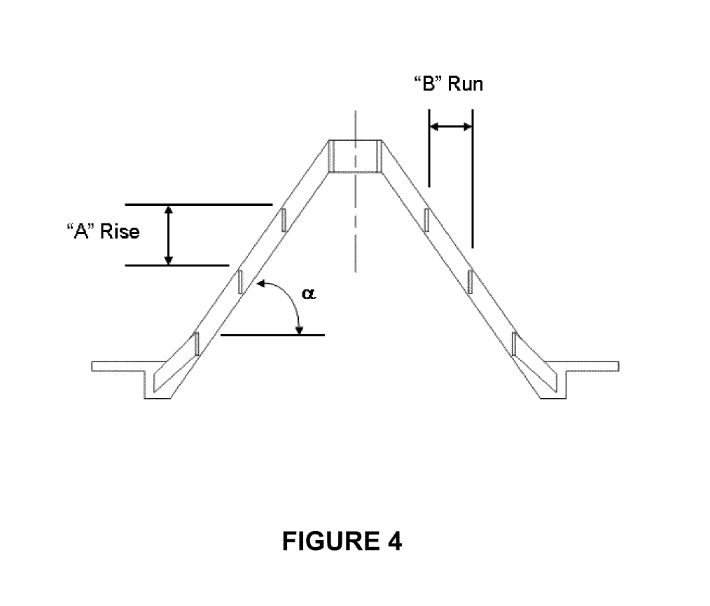

FIG. 4 illustrates a center cut view elevation view of an embodiment of the debris separation device. In preferred embodiments, the angled vertical plate members 16 create a conical angle α of from about 20 degrees to about 75 degrees, more preferably a conical angle α of from about 30 degrees to about 65 degrees, from the horizontal plane of the device. FIG. 3 also shows the rise A and the run B dimensions for a specific tier. In preferred embodiments the rise A and the run B dimensions will be approximately set as a function of the conical angle α and the diameter of the FCC vessel.

The dimensions of the debris separation device 10 can vary with the desired location as well as vessel size within the FCC unit.

The debris separation device 10 includes multiple tiers 12 and each tier contains a plurality of flow apertures 14. The tiers 12 are positioned in the vertical plane of the device and can range in number from about 1 to about 10, preferably from about 1 to about 5, and more preferably from about 1 to about 3. The apertures 14 are positioned in the horizontal plane of each tier 12 and can range in number from about 8 to about 32, preferably from about 8 to about 24, and more preferably from about 12 to about 20, for each tier. As illustrated in FIGS. 1A and 1B, in a preferred embodiment, the angled vertical plate members 16 (and thus the resulting aperture widths) are positioned at substantially equal spacing (i.e., angles) around the debris separation device 10. The structural design of the device 10 should be sufficient to reduce the pressure drop by expanding each screening area into multiple vertical tier levels 12 that establish open process flow areas.

The shape and size of the flow apertures 14 can vary and need only be sufficient to collect the desired size and shape of debris particles. The size and shape of the apertures 14 desirably promote, support, and otherwise serve to create and/or maintain operating throughput as debris particles, including coke deposits, are collected. Illustrative aperture shapes include, for example, a rectangular shape, an isosceles trapezoid shape, an isosceles triangular shape, and the like. In preferred embodiments, the flow aperture 14 area ranges from about 10 to about 180 square inches, preferably from about 15 to about 165 square inches, and more preferably from about 20 to about 150 square inches (the aperture area being as measured along the outer surface of the cone).

It is also preferable to design the apertures to be within a range of maximum open dimensions. The maximum open dimension of an aperture is defined herein as the maximum open linear (non-curvatured) dimension of an aperture as measured along the face of the aperture (i.e., face of the conical structure). In preferred embodiments, the flow apertures 14 have a maximum open dimension of less than about 20 inches, preferably less than about 15 inches, and more preferably less than about 12 inches. As a note, all of the aperture dimensions are as measured on the outside surface of the substantially conically shaped structure unless otherwise specified herein.

In preferred embodiments, additional aperture segregation plates (not shown) can be installed to reduce the open area of some of the larger flow apertures 14, typically in the bottom-most tiers 12 of the debris separation device 10. When this is done, the aperture numbers and dimensions as described above, apply to each of the segregated apertures and aperture areas defined by the new, reduced apertures.

The disclosure provides a debris collection and separation system that can include an automatic detection-control system. In a preferred embodiment, the FCC vessel is equipped with a pressure device to measure the pressure drop across the debris separation device and send a remote signal when a pressure indicative of an undesirable level of debris particle build-up is reached. Such devices can improve the reliability of the system as well as provide a preemptive indication if the device has been subjected to significant flow area reduction which may affect the FCC process or the mechanical integrity of the system.

While this disclosure has been described in connection with FCC units and processes, it is to be understood that the disclosure is not limited and is applicable to any process that involves separating debris from a flowing stream.

Various modifications and variations of this disclosure will be obvious to a worker skilled in the art and it is to be understood that such modifications and variations are to be included within the purview of this application and the spirit and scope of the claims.

What is claimed is:

1. A device for use in separating debris from a flowing stream in a fluidized catalytic cracking vessel which comprises:
a substantially hollow, conically shaped structure comprising a top end member and a plurality of adjacently positioned angled vertical plate members angularly extending from the top end member and forming a circular bottom end;
wherein the top end member has a smaller diameter than the circular bottom end;
wherein the adjacently positioned angled vertical plate members are secured together and to the top end member, and configured to provide multiple tiers in a vertical plane in the substantially hollow, conically shaped structure;
wherein the multiple tiers comprise a plurality of apertures in a horizontal plane in the substantially hollow, conically shaped structure, the plurality of apertures configured for separating debris particles from a flowing stream, and directing the debris toward the circular bottom end; and
wherein the circular bottom end is mechanically attached to the internal wall of a fluidized catalytic cracking unit vessel and provides effective screening of the entire diameter of the fluidized catalytic cracking unit vessel at the plane in the fluidized catalytic cracking unit vessel where the circular bottom end is mechanically attached to the internal wall of the fluidized catalytic cracking unit vessel.

2. The device of claim 1 wherein said adjacently positioned angled vertical plate members each comprise a flat elongated plate-like structure having a top end and a bottom end, a front side and a back side, and a plurality of flat elongated plate-like structures extending from said front side; wherein said top end of the angled vertical plate is capable of being secured to said circular top member, said bottom end of the angled vertical plate is capable of being positioned and secured on said support structure, and said plurality of flat elongated plate-like structures are capable of being secured to an adjacently positioned angled vertical plate member.

3. The device of claim 1 wherein said circular bottom end is connected to the internal wall of the fluidized catalytic cracking unit vessel by means of at least one support member.

4. The device of claim 1 wherein an annular area is formed between the circular bottom end of the device and the internal wall of the fluidized catalytic cracking unit vessel wherein the debris particles are allowed to collect.

5. The device of claim 4 wherein said annular area contains apertures that allow the flow of a portion of the flowing stream to pass through the device in said annular area while retaining at least a portion of said debris particles in said annular area.

6. The device of claim 5 wherein the circular bottom end is further comprised of a plurality of annular extension members which extend into said annular area.

7. The device of claim 1 wherein at least a portion of the apertures contain aperture segregation plates to reduce the open area of the apertures.

8. The device of claim 1 wherein said apertures have an isosceles trapezoid shape.

9. The device of claim 1 having from about 1 to about 20 tiers.

10. The device of claim 1 wherein each said tier has from about 8 to about 32 apertures.

11. The device of claim 1 comprising apertures with open areas ranging from about 10 to about 180 square inches.

12. The device of claim 1 comprising apertures with a maximum open dimension of less than about 15 inches.

13. The device of claim 1 wherein the top end member is comprised of a hollow ring wherein the hollow ring has an internal diameter from about 12 inches to about 24 inches.

14. The device of claim 13 wherein slide plates are attached to the top end member.

15. The device of claim 1 wherein said top end member is conical or cylindrical in shape.

16. The device of claim 1 wherein said device is substantially in the shape of a truncated cone.

17. The device of claim 1 wherein the conical angle, α, is from about 20 degrees to about 75 degrees as measured from the horizontal plane of the device.

18. The device of claim 1 wherein the device is comprised of at least one material selected from carbon steel, carbon-1/2 moly steel, and stainless steel.

19. A method of separating debris from a flowing stream in a fluidized catalytic cracking vessel which comprises:
(a) providing a debris separation device comprising:
a substantially hollow, conically shaped structure comprising a top end member and a plurality of adjacently positioned angled vertical plate members angularly extending from the top end member and forming a circular bottom end;
wherein the top end member has a smaller diameter than the circular bottom end;
wherein the adjacently positioned angled vertical plate members are secured together and to the top end member, and configured to provide multiple tiers in a vertical plane in the substantially hollow, conically shaped structure;
wherein the multiple tiers comprise a plurality of apertures in a horizontal plane in the substantially hollow, conically shaped structure, the plurality of apertures configured for separating debris particles from a flowing stream, and directing the debris toward the circular bottom end; and
wherein the circular bottom end is mechanically attached to the internal wall of a fluidized catalytic cracking unit vessel and provides effective screening of the entire diameter of the fluidized catalytic cracking unit vessel at the plane in the fluidized catalytic cracking unit vessel where the circular bottom end is mechanically attached to the internal wall of the fluidized catalytic cracking unit vessel.
(b) flowing a stream containing debris particles through the device;
(c) separating debris from the flowing stream; and
(d) directing the debris toward the circular bottom end.

20. The method of claim 19 wherein the debris particles are comprised of coke and spent catalyst.

21. The method of claim 20 wherein said circular bottom end is connected to the internal wall of the fluidized catalytic cracking unit vessel by means of at least one support member.

22. The method of claim 20 wherein an annular area is formed between the circular bottom end of the device and the internal wall of the fluidized catalytic cracking unit vessel wherein the debris particles are allowed to collect.

23. The method of claim 22 wherein said annular area contains apertures that allow the flow of a portion of the flowing stream to pass through the device in said annular area while retaining at least a portion of said debris particle sin said annular area.

24. The method of claim 19 comprising apertures with open areas ranging from about 10 to about 180 square inches.

25. The method of claim 24 comprising apertures with a maximum open dimension of less than about 15 inches.
